(19) United States
(12) Patent Application Publication
(10) Pub. No.: US 2014/0211931 A1
(43) Pub. Date: Jul. 31, 2014

(54) System and Method for Generating and Delivering Automated Reports Concerning the Performance of a Call Center

(71) Applicant: NORTH AMERICAN COMMUNICATIONS RESOURCES, INC., Eagan, MN (US)

(72) Inventor: Scott J. Wendt, Kissimmee, FL (US)

(73) Assignee: North American Communications Resources, Inc., Eagan, MN (US)

(21) Appl. No.: 13/755,800

(22) Filed: Jan. 31, 2013

(51) Int. Cl. H04M 3/51

(52) U.S. Cl. CPC H04M 3/5175
USPC 379/265.03

(57) ABSTRACT

Transformation of binary data files created by a data logger of a telephone system used by a call center into a searchable form for generation of meaningful management reports concerning the operation and performance of a call center, its agents and equipment is accomplished by providing a report server which u, under software control, processes the data in the log file to complete fields of tables in a database. The database is then used to create and deliver management reports both automatically and in response to queries entered by supervisors.

### CROSS-REFERENCED TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

I. Field of the Invention

The present invention relates to call centers which process large volumes of calls. More specifically, the present invention relates to the automated generation of reports to aid in the assessment of the call center, the performance of equipment used by the call center, and the agents working in the call center.

II. Description of the Prior Art

Call centers are operated by various government, charitable and business organizations throughout the world. Such organizations use call centers to initiate telephone calls to members of the public or to field telephone calls received from members of the public. It is not at all unusual for such call centers to be staffed by hundreds of agents. The call center serves as a central point of contact between the organization and the outside world.

The performance of the call center, the agents working in the call center, and the call center's equipment is vital to the effectiveness of the organization and its reputation. The equipment must operate at optimal efficiency for calls to be handled effectively. Likewise, agents must be properly trained and work diligently at their jobs. Quality control is of keen importance to organizations operating call centers. As call centers have grown in size, management of equipment and agents has become increasingly difficult.

Currently available call center equipment generates vast quantities of data related to the operation of a call center. This data is generally used by the call center equipment to route calls or the like. This data also has the potential to reveal important details about each agent's productivity and performance and the experience the call center provides to each person placing a call to, or receiving a call from, the call center. However, to date there has been no system or method which has been able to gather, organize, interpret, and report such data to managers and supervisors in a manner which unlocks the full potential and value of such data.

More specifically, there has been no system or method which enables such data to be processed in near real time to enable managers and supervisors to understand current calling patterns; identify agent patterns involving unacceptable attributes such as long call segments, excessive hold times and frequent disconnects; determine average time from ring to answer or disconnect to placement of a next call; identify hang-ups or malicious calls; pinpoint and repair equipment failure while it is occurring; or rate the efficiency of the call center, its agents or its equipment by understanding interactions at the call or caller level. Thus, there is a real need for systems and methods which are automated, easy to use and provide this functionality resulting in increased call capacity and call volume, improved agent productivity, reduced downtime, improved customer satisfaction, and reduced costs.

### SUMMARY OF THE INVENTION

Modern call centers operate using various types of telephone equipment. Often, the telephone equipment of the call center is interconnected by an Ethernet Local Area Network (LAN) and connected to an external telephone exchange or even the Internet by a gateway. At the center of the LAN is a switch or hub which provides a communications path between the workstations used by agents and a communication server. The workstations may comprise only a desk phone. Typically, however, the workstations also comprise a personal computer terminal coupled to the desk phone. The communication server routes calls to and from the various workstations. In doing so, large quantities of data are generated related to call traffic and utilization of the workstations. While this data is used by the communications server, it is not organized in such a way that it is available to managers or supervisors of the call center or usable in a meaningful way by such managers and supervisors.

In addition to the above-described equipment, the system of the present invention includes a data logger. This data logger is typically a computer coupled to the network which logs vast quantities of data related to incoming and outgoing calls, and the operation of the communication server and each workstation of the call center. The system of the present invention also includes a report server which processes the log files created by the data logger to transform the data into a useful form. The transformed data is then used to generate management reports.

More specifically, the data logger typically comprises a first processor, a first storage, at least one first communications port, and a first application program which controls the data logger such that the data logger ingests through the at least one communications port data related to a plurality of calls handled by the call center, creates a log file containing said data, and stores the log file in the first storage. The report server comprises a second processor, a second storage, a database stored in the second storage, at least one second communications port, operating system software, and a second application program. The second application program cooperates with the operating system software of the report server to control the report server such that the report server retrieves from the data logger the log files created by the data logger and then processes the log files. Such processing involves several steps.

First, the report server communicates with the data logger through the at least one first communications port and the at least one second communications port to retrieve the log file. The report server then stores the log file in a temporary storage location in the second storage, checks to make sure that the log file has been properly stored in the temporary storage location, and then deletes the log file from the first storage. Second, the report server transforms the data contained in the log file stored in the temporary storage location into a searchable form by creating in the database, for each of the plurality of calls, a separate set of tables (or set of fields in a single table). Each set of tables (fields) contains data from the log file related to a single call of a plurality of calls. Third, the report server creates or completes in the database at least one table containing data related to the processing of the log file and any errors occurring during the processing of the log file. Fourth, using the database, the report server generates management reports in near real time including information related to at least one topic selected from a group of topics consisting of operation of the call center equipment, performance of the call center or call center equipment, and performance of agents handling calls for the call center. These reports may be e-mailed to one or more managers, sent directly to a printer attached to the network, or stored as a report file on the network in a manner which permits the report file to be retrieved by one or more managers. The call center report generation apparatus will also typically include a management work station, which may be a personal computer attached to the LAN, to which e-mail reports are sent or which may be used by a manager to retrieve a report stored on the system. Additional management workstations may be provided as desired or needed. The second application program of the report server may also function to cause the report server to assemble and deliver the management reports in near real time to the management workstation(s) based on queries entered using a workstation.

Other functions may also be performed by the report server. For example, the report server may periodically check for and process any new log files stored in the first storage of the data logger. The report server may also function to create an archival copy of the log file and store the archival copy for a predetermined period of time to preserve the raw log file. The application software of the report server may be customized to, for example, permit selection of the types of data stored related to errors occurring during processing of the log files. The application program and operating system software of the report server may also cooperate to permit the database to be queried by authorized users via the Internet such that custom reports may be generated and delivered to remote locations. These and other advantages and attributes of the present invention will become clear to one of ordinary skill in the art from a reading of the following detailed description in view of the accompanying drawings.

### BRIEF DESCRIPTION OF THE DRAWINGS

FIG. 1 is a schematic diagram of the call center equipment which may be employed when practicing the present invention.

FIG. 2 is a flow chart illustrating installation of the application program of the present invention.

FIG. 3 is a flow chart illustrating how the application program is customized and configured.

FIG. 4 is a flow chart illustrating the data collection and database population steps of the present invention.

FIG. 5 illustrates the “ErrorLog” table of the database.

FIG. 6 illustrates the “Events” table of the database.

FIG. 7 illustrates the “Processed” table of the database.

FIGS. 8A-8C illustrate the “Record” table of the database.

FIGS. 9A-9C illustrate the “Splits VDNs” table of the database.

FIGS. 10A-10B illustrate the “Time” table of the database.

FIGS. 11A-11B illustrate the “Work Codes” table of the database.

FIG. 12 is a sample automatic call distribution report.

FIG. 13 is a sample call disposition report.

FIG. 14 is a sample dialed number identification report.

FIG. 15 is a report comparing the calls taken by the various groups of agents having different skills.

FIG. 16 is a report showing how calls were handled by the call center.

FIG. 17 is a report providing a breakdown of how time was spent handling the calls.

FIG. 18 is a call disposition report.

### DETAILED DESCRIPTION

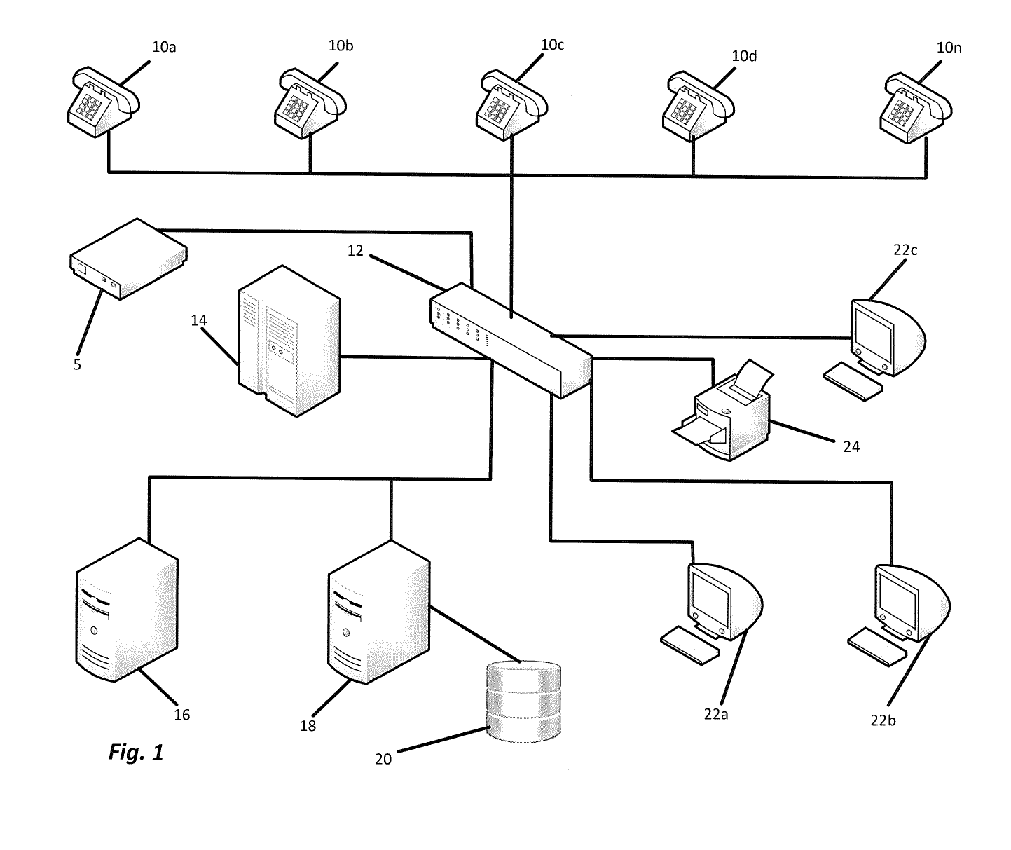

The present invention relates to the management of call centers used by various organizations to receive and process telephone calls or place telephone calls. FIG. 1 provides an example of the equipment that may be employed by a call center using the management tools provided by the present invention.

The equipment will typically include a gateway 5 which connects the call center to an external telephone exchange or even the Internet (not shown). All incoming calls and all outgoing calls are processed by the gateway 5.

At the center of the call center is a switch 12. The switch 12 provides an avenue of communication between the various internal devices used by the call center, including the gateway 5. The switch 12 may be, for example, any type of switch used on an Ethernet Local Area Network (LAN). Likewise, the gateway 5 may be any type of gateway typically used to connect a LAN to external networks such as a telephone network or the Internet.

As shown in FIG. 1, the call center has a plurality of workstations 10a-10n. While five are shown, the number of workstations will vary depending upon the call center. A call center could, by way of example, have more than 100 or even more than 1000 workstations. Such workstations can be essentially any telephone. In many call centers, the workstations include both a desktop PC (or terminal) and an IP phone to provide increased capabilities and an improved graphical user interface to the agent using the workstation. To control traffic to and from the workstations 10a-10n, a communications server 14 is provided. The communications server 14 receives various inputs related to the status of each workstation, e.g., what agent is assigned to the workstation, is the agent available to take a call, is the agent on a call, is the call on hold, how many calls in the agents queue are waiting to be answered, what is the duration of the current call. The communications server 14 uses this information collected from each of the workstations 10a-10n and other information to route calls to the workstations 10a-10n. Modern communications servers collect or create all data necessary to monitor all call traffic and performed by or using the workstations.

In addition to monitoring the workstations 10a-10n, the communications server 14 monitors all incoming and outgoing call activity, the operation of the gateway 5 and the operation of the switch 12. The communications server may also operate as an automated attendant answering calls, communicating a menu of options the caller can select from using the number keys on the caller's phone, recording caller selections, queuing up calls for specific agents or groups of agents based upon the training and level of the agents, and routing calls accordingly.

Initially, data of the types described above was only used by the communications server 14 to control the operation of the call center equipment. More recently, suppliers of call center equipment have offered appliances that log such data. A data logger 16 is shown in FIG. 1. An example of such a data logger 16 is the call management system server offered by Avaya Inc. of Basking Ridge, N.J. Typically, data logger 16 comprises a processor, memory, storage and at least communications port such as a network interface card. Data logger 16 is essentially FTP servers which typically stores for at least some period of time in a binary file the signals received, delivered and processed by the communications server 14. Such data has very little utility in this raw, disorganized form. Recognizing this, some data loggers 16 are programmed to produce very rudimentary reports, but such reports have proven to be of little value when managing the call center equipment or employees of the call center. Therefore, the present invention includes a call center report generation apparatus which typically includes a separate report server 18 and a database 20. In certain cases, the attributes of the report server 18 may be integrated into another device used by the call center such that the functions of the report server 18 are performed by the other device. Herein, the term “report server” and any references to a “report server” include the separate report server 18 shown and, alternatively, any other device(s) performing the functions of the report server 18.

The report server 18 automatically ingests raw data from the data logger 16, stores the data in a usable form in the database 20, and generates various management reports, all in near real time, related to the operation of the call center, the performance of the call center equipment, and the effectiveness and efficiency of the agents. These reports may be delivered to one or more management workstations 22a-22n or directly to a printer 24. Such reports may also be stored in a storage device coupled to the network so the reports can be accessed using any of a variety of devices. Managers can also use the workstations 22a-22n (or an external computing device connected to the call center equipment via the Internet and gateway 5) to create customized reports by creating queries which retrieve desired information in a desired manner from the database 20.

In one embodiment, the report server 18 may comprise a computer having a dual core 1.7 GHz processor, 4 GB of RAM, a 250 GB hard drive on which the database 20 is stored and a network interface card. A processor of other speeds or a different number of cores may also be used. Likewise, other RAM memory and hard drive configurations may be employed. The network interface card employed will depend on the type of network (e.g., Ethernet) and speed of the other devices (such as the switch 12) employed.

In one embodiment, various operating system software programs will be installed on report server 18. By way of example, these may be various products offered by Microsoft Corporation of Redmond, Wash. including (1) Windows Server 2003 or 2008; (2) Microsoft Message Queuing Server; (3) Microsoft Net Framework 4.0; (4) MDAC; (5) Microsoft SQL Server 2005, 2008, or 2008 R2; and Microsoft's FTP server available for Windows Server. Of course, other similar operating system programs may be used without deviating from the invention. For example, any reliable FTP server program may be used and Oracle 11, a database software program offered by Oracle, Inc. of Santa Clara, Calif., may be used instead of a Microsoft SQL Server.

FIG. 1 shows report server 18 and database 20 being separate devices on the network. The database 20 may be stored on a single storage device such as a hard drive, or on an array of storage devices. The database 20 may also be stored on a separate storage device as shown or on an internal storage device (or array of storage devices) of the report server 18. As noted above, the functions performed by report server 18 and database 20 can be performed by a number of other devices on the network such as server 14, data logger 16 or any of the management workstations 22a-22n so long as the device used has sufficient hardware and software resources.

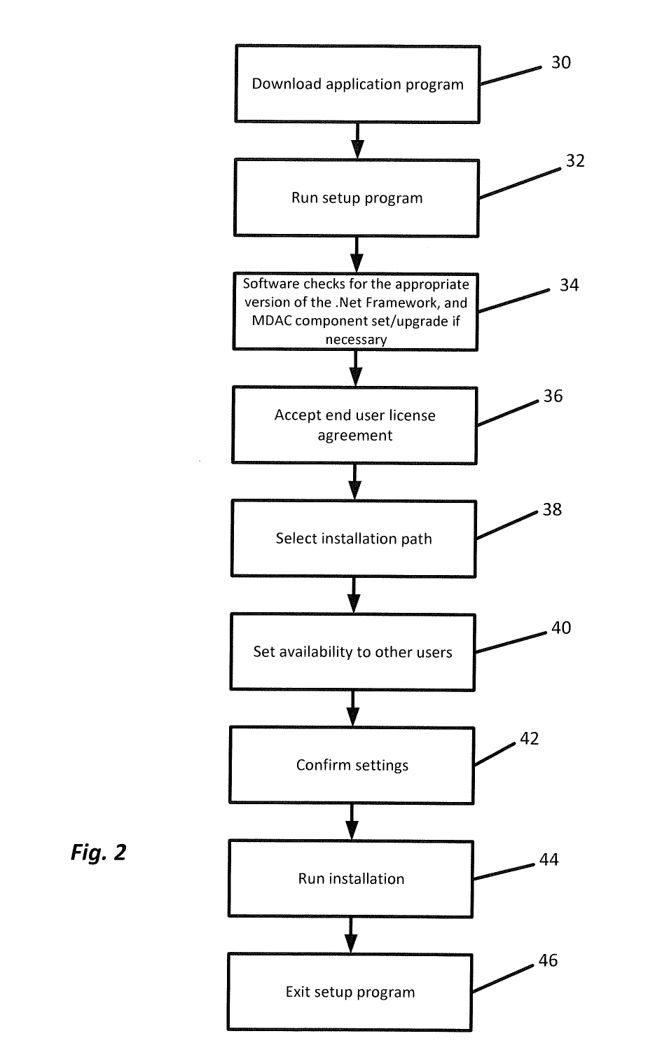

In addition to the aforementioned operating system programs, the report server 18 of the present invention includes an application program. FIGS. 2-11B illustrate the features of the application program and the manner in which it operates.

Installation of the application program is illustrated in FIG. 2. At step 30, the application program is downloaded onto, or otherwise made available to, report server 18. The user then initiates a setup program at step 32. At step 34, the setup program performs a software check to ensure that the necessary operating system programs have been installed. If not, the setup program mandates the installation of such operating system programs and any updates to the operating system programs as may be required. After all necessary operating system programs (and necessary updates) are verified as having been installed, the setup program proceeds to step 36 and requires the user to accept the end user license agreement for the application program.

At steps 38-42, the person installing the application program must select and then verify certain settings. Specifically, at step 38 the user selects an installation path and at step 40 the user specifies whether only that user or that user and other users will be permitted to access the application program. After these settings are confirmed at step 42, the application program is automatically installed at step 44 in accordance with the selected settings. After installation is complete, the set up program terminates at step 46.

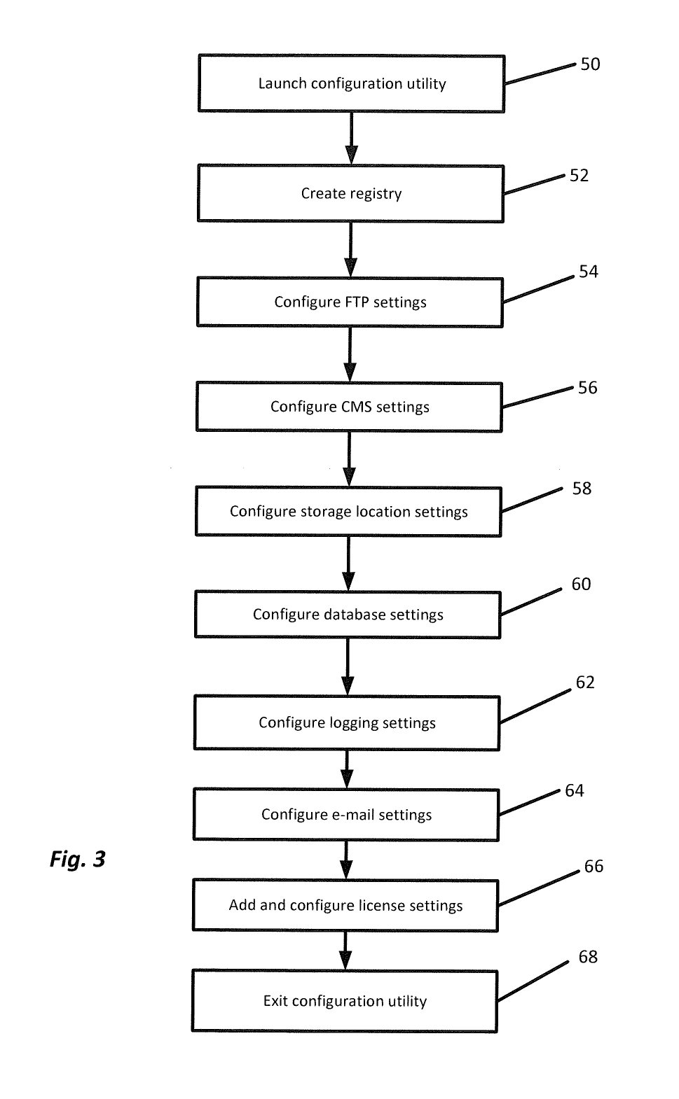

After the application program is installed, the application program is then customized and configured as illustrated in FIG. 3. The configuration utility is launched at step 50. A registry is then created at step 52.

At step 54, various FTP settings are configured. These are vital for the application program to access the data generated by the data logger 16. These settings include the FTP server address of the data logger 16 as well as the FTP user name and FTP password required to gain access to the log files created by the data logger 16.

So the application program can decipher the data generated by the data logger 16, the version of the software used by data logger 16 to generate that data must be available to the application program of the report server 18. This is supplied at step 56.

The configuration utility also allows the user to select, at step 58, the directory used by the application program to store temporary files retrieved from the data logger 16 while the temporary files await processing by the application program. The user can also select a storage location where archived copies of these temporary files are stored after processing and the period of time during which the archived copies are retained.

The application program can operate in conjunction with various database arrangements made available by the specific database program used as part of the operating system programs. For example, Microsoft SQL Server 2008, native SQL server, OLE, ODBC and Ling to SQL are all options that may be used. One must be selected. This occurs at step 60.

The application program has the ability to self-monitor and create logs concerning its own operation. At step 62, the user can specify whether a log should be created and, if so, the level of detail to be included in the log. If a log is to be created, the options include:
Informational: All types of logging messages are retained. This is the most verbose form of logging and should be used with extreme care. It can log upwards of 10 MB of logging data in less than 2 minutes time. Only use this setting when attempting to troubleshoot parsing or database connection issues.
Minor: Minor level, major level, fatal level and all status/startup messages are logged. This level of logging is less fine in detail, but provides an understanding of errors as they occur, and the reasons behind the errors.
Major: Major level, fatal level, and all status/startup messages are logged. This level of logging only tracks issues that may have adverse effects on the parsing and processing of the various files.
Fatal: This logs the fatal, status and startup messages only, and will only provide fatal errors that may or do cause the service to stop processing and shut down, or stop processing a particular file.
   At step 64, the user can provide one or more e-mail addresses. Alerts are sent to the provided e-mail addresses to warn of any problems related to the operation of the application program.

The configuration process is concluded by permitting users to add a license or view current license details to ensure any and all licenses required for the relevant users and equipment are in place. This occurs at step 66. Once the configuration process is complete, the configuration utility is exited at step 68 and all selected configuration options are stored for use by the application program.

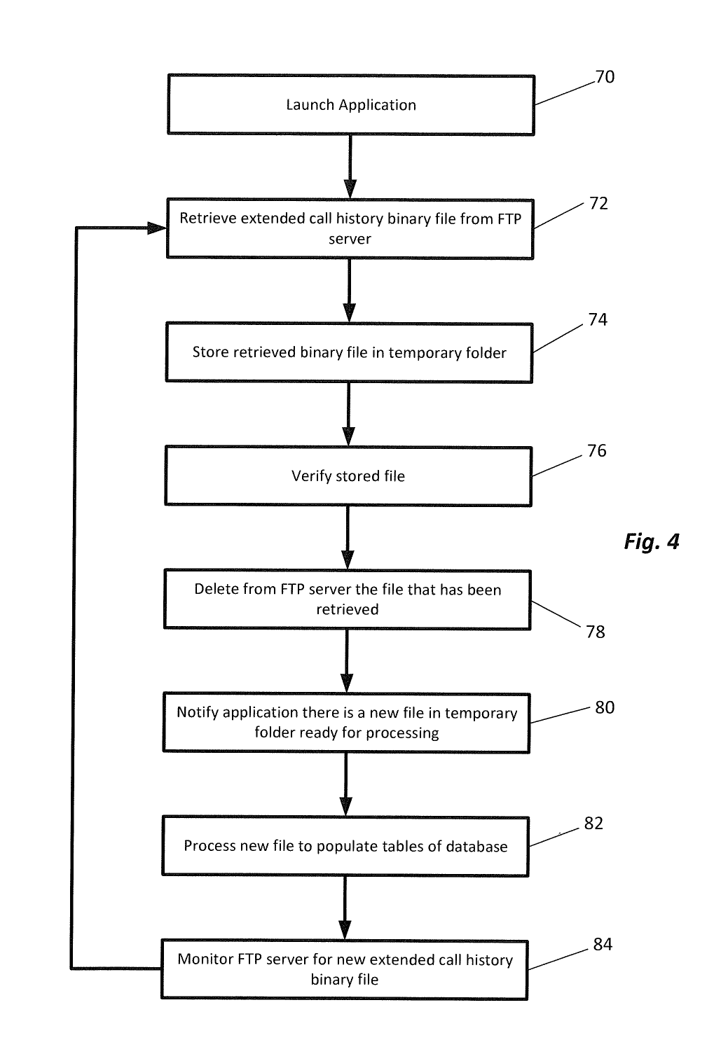

Before the report server 18, under the control of its application program, can generate any meaningful reports, it must acquire the data files to be employed from the data logger 16. How such data is gathered and stored by report server 18 and the application program will now be described with reference to FIGS. 4-11B.

At step 70 of FIG. 4, the user launches the application program. At step 72, the application program, using the FTP settings identified at step 54, causes the server 18 to retrieve from the data logger 16 (which, in the embodiment described, is on FTP server) an extended call history binary file. At step 74, the retrieved binary file is stored in the temporary folder identified as part of step 58 of FIG. 3. To ensure the data was properly transferred from the data logger 16 to the server 18, the data is verified or checked at step 76.

Once the data transfer between logger 16 and report server 18 is complete, there is no need for the data to continue to reside on the storage of the logger 16. Therefore, the binary file is deleted from the data logger 16 at step 80. The application program then recognizes at step 82 there is a new temporary file ready for processing stored in the temporary directory.

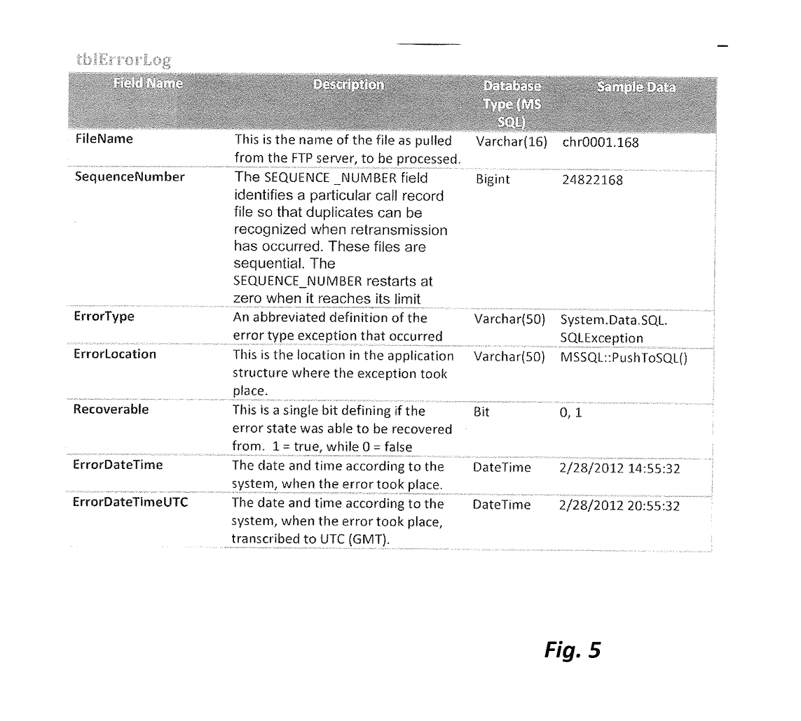

The data of the binary file now stored in the temporary file is then processed by the report server 18 under control of the application program. A copy of the temporary file is placed in the archive directory identified at step 58. More significantly, the file is processed and its contents are used to populate the tables of a database at step 84. The table structure of an exemplary database is illustrated by FIGS. 5-11b. Other table structures may be used without deviating from the invention.

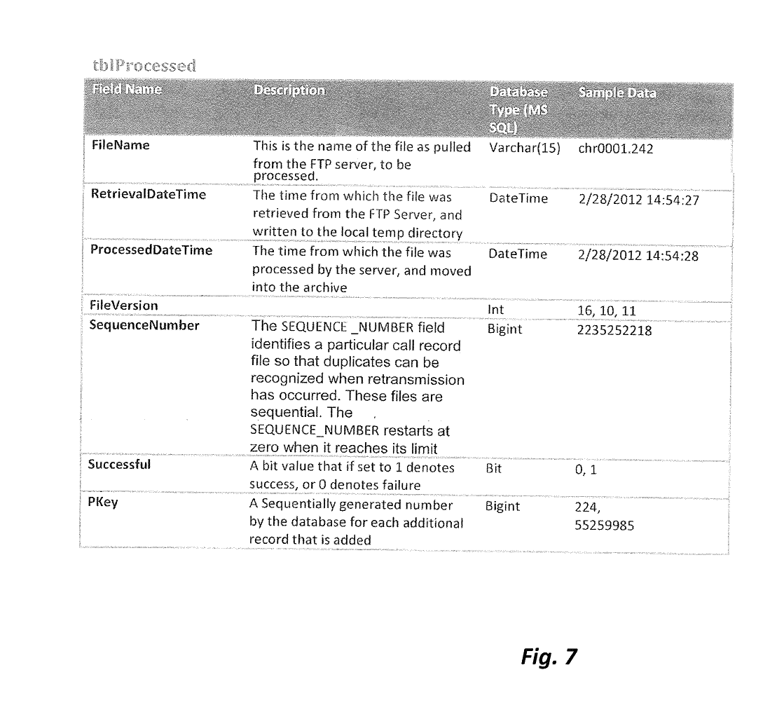

As illustrated, the database structure includes seven tables. Two of the seven tables (i.e., those illustrated in FIGS. 5 and 7) include information related to the processing and transformation of the log files. The remaining tables contain information from the log file related to each call and call segment.

More specifically, as the binary files from the data logger 16 are retrieved, stored in the temporary location and processed by report server 18, the error log table of the database is updated. FIG. 5 shows an exemplary error log table. This table is used to log any processing errors in the event processing of any temporary files could not be properly completed. The level of detail included will depend on the option selected at step 62 of FIG. 3 when configuring the application program of server 18. No data from the temporary file is stored in this table. It simply identifies the files which have not been fully processed and the reason. As illustrated in FIG. 5, for each error encountered, seven different fields are completed in the error log table. First, the name of the file as retrieved from the data logger 16 which, itself, is an FTP server, is noted in the table. Second, the sequence number is noted. The sequence number identifies a particular call record contained in the file retrieved from the data logger 16. The sequence numbers of calls are sequential and restart at zero when a limit is reached. The sequence number prevents duplication when processing (or reprocessing) to deal with errors.

Error type, error location and recoverable fields are also completed in the error log table. The error type field includes an abbreviated definition of the nature of the error which occurred. The error location field identifies the location in the application structure where the exception took place. The recoverable field is a single bit field. A “1” is put in this field if the application was able to recover from the error state. A “0” is put in this field if the application was not able to recover from the error state.

The final two fields completed in the error log table both show the date and time the error took place. One lists the local time. The other lists the time transcribed to coordinated universal time (UTC).

As files are retrieved from the data logger 16 and processed by the report server 18, fields of the processed table are completed for each sequence (i.e., portion of a call). FIG. 7 provides an example of a “Processed” table. This table provides a log of the temporary files that have been processed by the report server 18 and application software. This log is used by the application software to ensure the database does not include duplicate entries resulting from the same temporary file being processed twice. As illustrated, the name of the file retrieved from the data logger 16 (FTP server) is inserted into the table. The local time the file was retrieved from the data logger 16 and the local time it was processed by the report server 18 are inserted into the table. A file version is provided as well as the sequence number so that each call and call segment is uniquely identified. A single bit is used to indicate whether the sequence was successfully processed or whether there was a failure. “1” denotes success. “0” denotes failure. Finally, “Pkey” value is inserted into the table. This is a sequentially generated number reflecting each additional record added to the database.

As should be clear from the foregoing, the error log table shown in FIG. 5 and the processed table shown in FIG. 7 are used to manage and assess whether the log files have been properly retrieved and processed by report server 18.

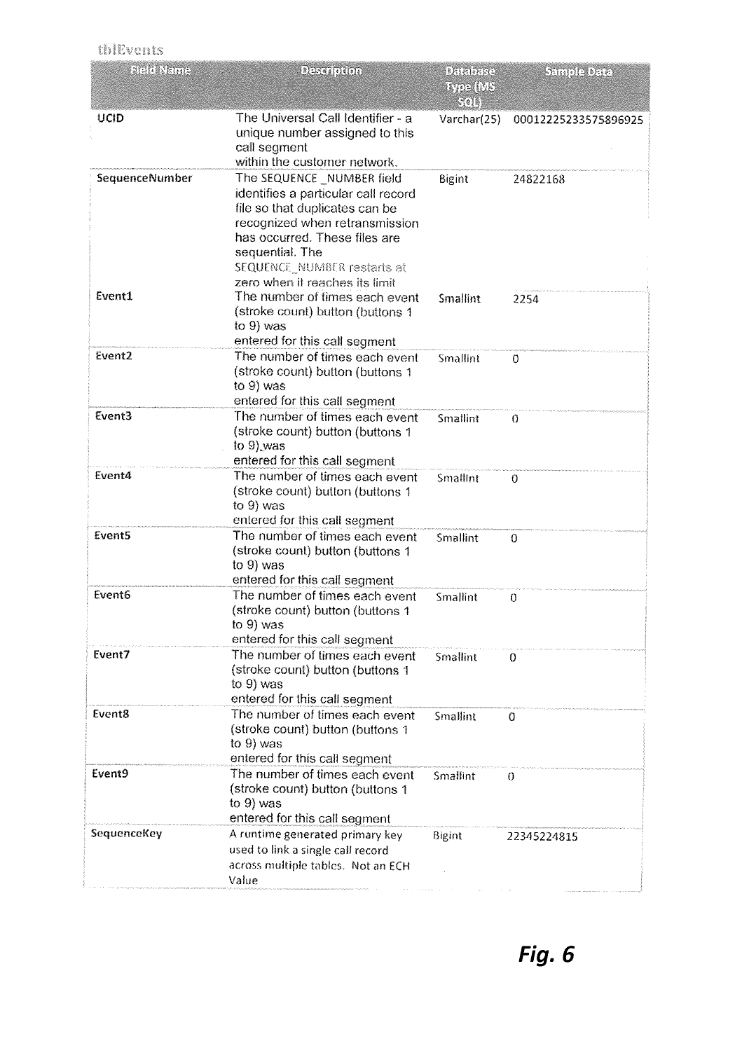

Each of the binary files transferred from the data logger 16 and processed by report server 18 may include data concerning more than 1000 individual calls or call segments. The organization of the log files makes this data generally unusable for generating meaningful reports. Thus, an important function of the application program is to cause the report server 18 to transform this data into a usable form. This data is transformed into usable information by the report server 18 as it is organized into tables, e.g., the tables illustrated in FIGS. 6, and 8A through 11B. The tables illustrated in FIGS. 6 and 8-11B are populated during the transformation process using with data related to each call and call segment initially collected and logged by the data logger 16.

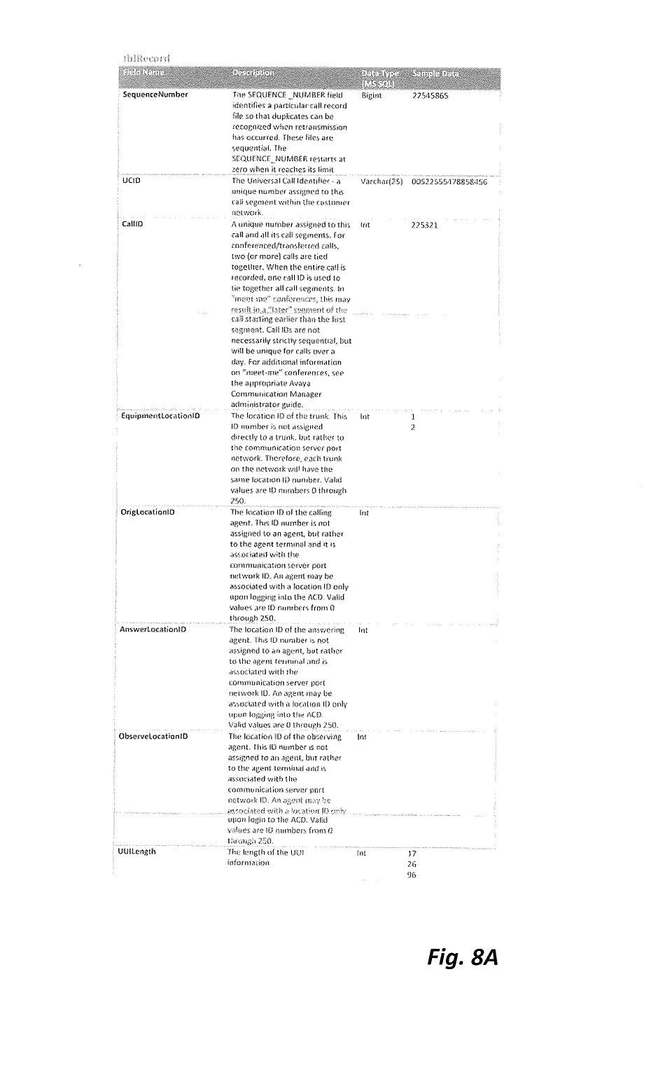

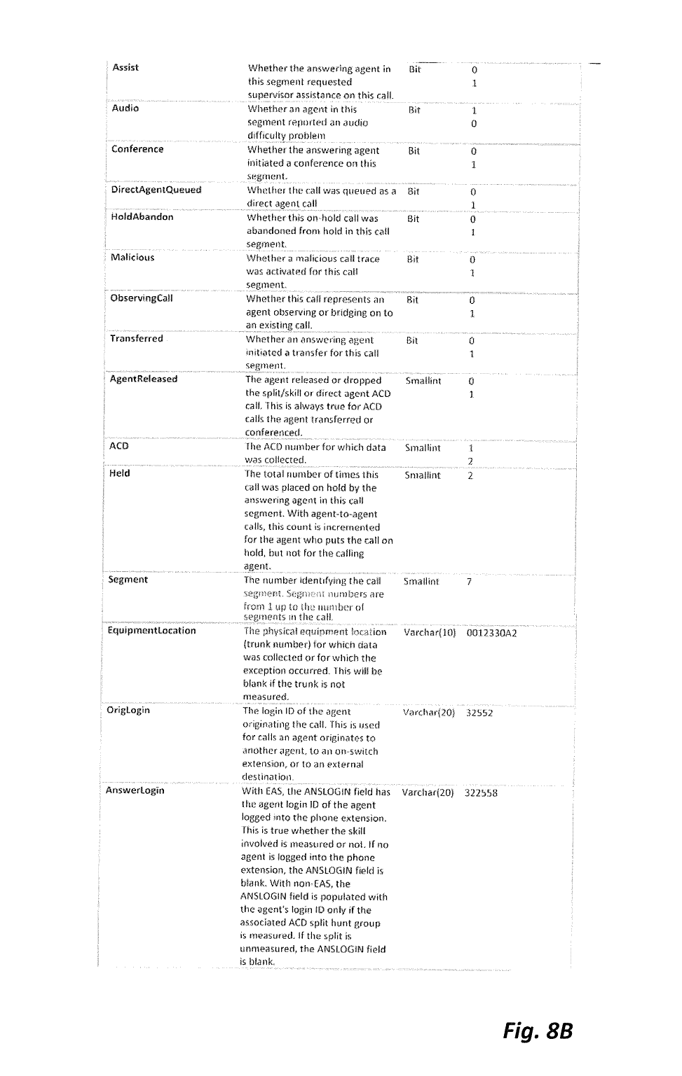

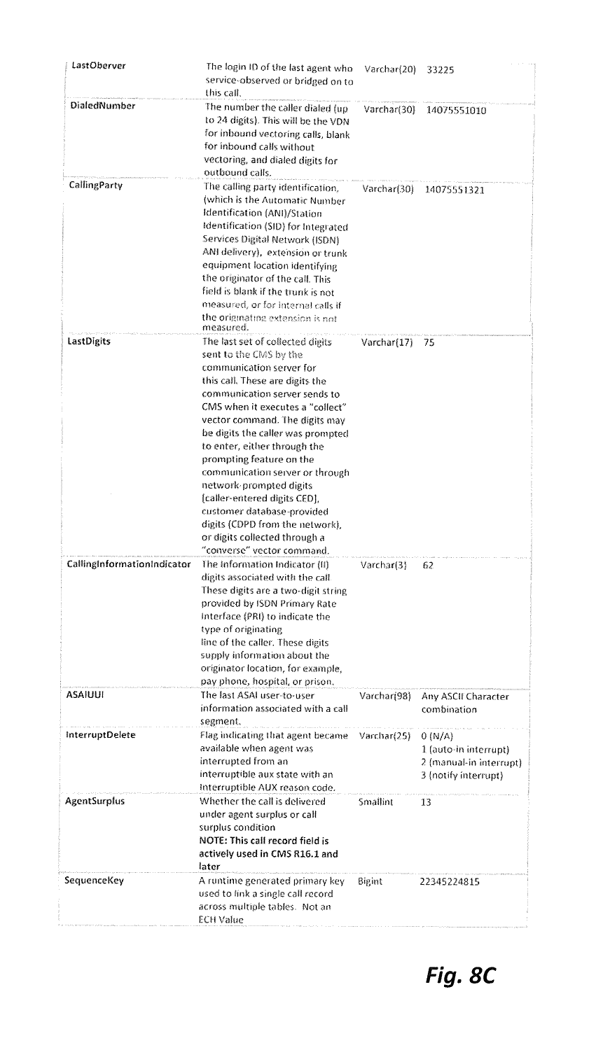

The events table of FIG. 6 is primarily used to record data collected related to menu selections made by a caller when using the automated attendant feature of the communication server 14. The events table is populated with a universal call identifier assigned to each call (segment), the sequence number discussed above with respect to the tables of FIGS. 5 and 7, and data related to how many times a caller made a specific menu choice by depressing one of the number buttons on the caller's phone. Specifically, during processing of the call or sequence data contained in the file from the data logger 16, the application program on the report server 18 determines how many times each of nine buttons on an outside caller's phone 10 was depressed during the call. These events, assigned to keys 1-9, of the outside caller's phone will vary from call center to call enter, but typically a party calling a call center will hear a set of recorded menu options and select those using such number keys on the caller's phone. The event fields simply indicate how many times the caller depressed each of buttons 1-9 in selecting menu options. These stroke counts are then recorded in the Event 1 through Event 9 fields. A sequence key value is also recorded in the table of FIG. 6. This sequence key, together with the sequence number and the universal call identifier, is recorded for the call also in each of the tables of FIGS. 8A-11B. This establishes a relationship between the data for each call/call segment in all of the tables 6 and 8A-11B.

FIGS. 8A-8C illustrate the Record table. To enable correlation of data in the Record table with related data in the other tables, the UCID, sequence number and sequence key are also recorded in the Record table. A callID is also provided for all calls which are transferred or handled as conference calls. This data relates the particular call segment to other call segments related to the same call. For example, when a call is transferred from workstation 10b to workstation 10c, there are two segments related to the same call. The callID is a unique number assigned to both of these two segments showing them to be related.

Another piece of data included in the log created by the data logger 16 may be used to identify the trunks on the network used for a particular call segment. As part of the data transformation process, a trunk identifier (0 through 250) is added to the Record table of FIGS. 8A-8C as is an equipment location ID.

The data logger 16 also records information related to the workstations 10a-10n which handled the call segment. During the transformation process, the report server 18 identifies and records up to three additional types of location information related to the segment. These include the workstation which originated the call transfer or convergence (OrigLocationID), the workstation which received the call transfer or conference (AnswerLocationID), and any workstation which was used to monitor or observe the call (ObserveLocationID). The DUI information can also be recorded.

The Record table, as illustrated at the top of FIG. 8B, also includes nine different single bit indicators identifying whether or not nine different events occurred during the call segment. A “1” indicates the particular type did occur. A “0” indicates the event did not occur. These include whether the assistance of a supervisor was requested (Assist), whether audio issues were reported by the agent during the call (Audio), whether the agent initiated a conference with one or more other agents (Conference), whether the call was directed to the specific agent (DirectAgentQueued), whether a call placed on hold resulted in the caller or call recipient hanging up while the call was on hold (HoldAbandon), whether a trace was placed on the call (Malicious), whether the segment was monitored by another agent (ObservingCall), whether the agent transferred the call (Transferred), and whether the agent released the call to another agent or completed the call (AgentReleased).

Often, agents working in a call center are assigned to automated call distribution groups. For example, some agents may be assigned to one or more sales groups while others may be assigned to one or more technical support groups. Each of these groups may be assigned a number. The data logger 16 records the number of the group which handled the call segment. This number is stored in the ACD field of the Record table as illustrated in FIG. 8B. The number of times the call was placed on hold during the segment is recorded in the “held” field. The segment number is also stored. The identification resources of the gateway 5 or communications server 14 employed during the segment is recorded in the EquipmentLocation field.

To use the workstations 10a-10n, an agent must log in. The “login” data is recorded by the data logger 16 when a call is transferred between agents. Specifically, the agent who transferred the call is identified in the Origlogin field and the agent to whom the call was transferred is identified in the AnswerLogin field. If the call was monitored, the login information of the observer is stored in the LastObserver field.

Call centers can typically be reached from the outside using multiple telephone numbers. Being able to identify which calls were placed using a specific telephone number has utility when evaluating advertising programs or diagnosing issues with calls placed to particular numbers. Likewise, call centers can benefit from knowing what phone numbers were called by the call center. This data is stored in the DialedNumber field. An identification of the calling party is reflected in the CallingParty field as part of the data transformation process performed by the application program and report server 18.

Those who have called a call center have experienced hearing a request to enter an account number. This number is often used to call up caller account information and display it on the workstation 10a-n of the agent. This data is stored in the ASAIUUI field.

The InterruptDelete and AgentSurplus fields are used to indicate the status of the agent who handled the call segment just before the time the call was delivered to the agent.

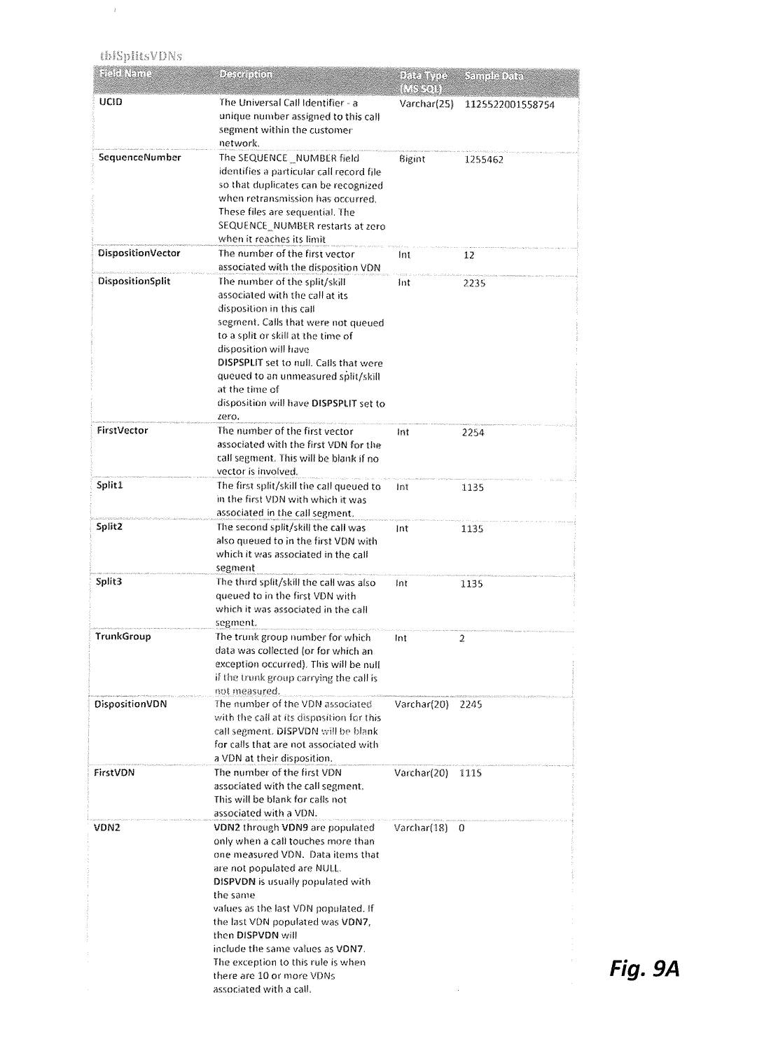

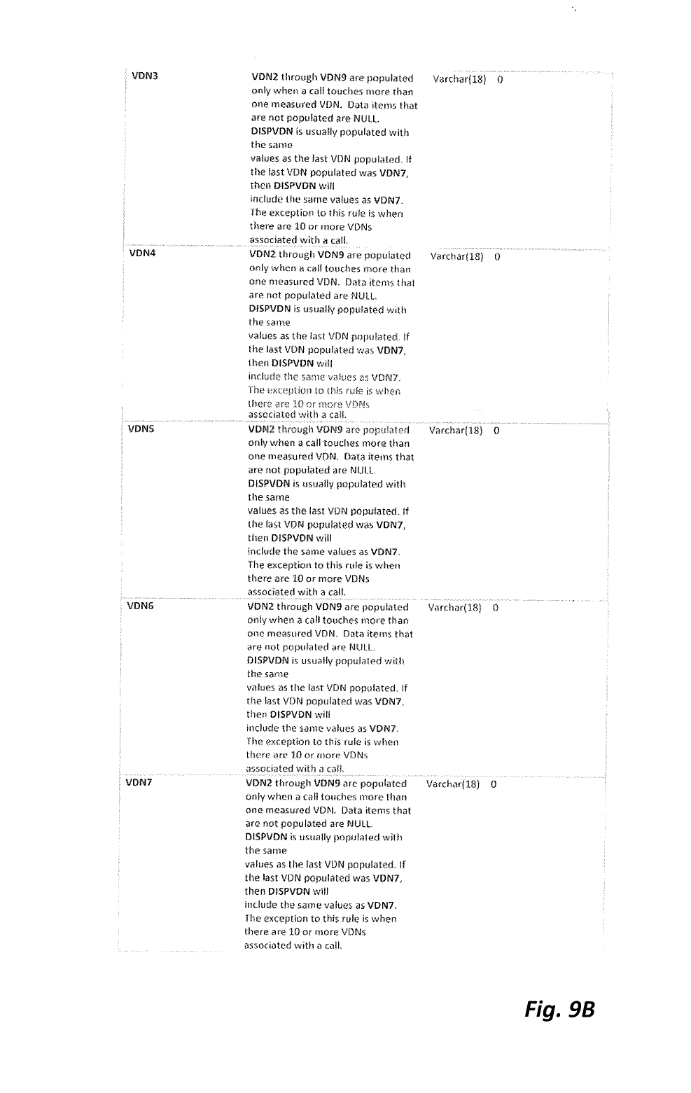

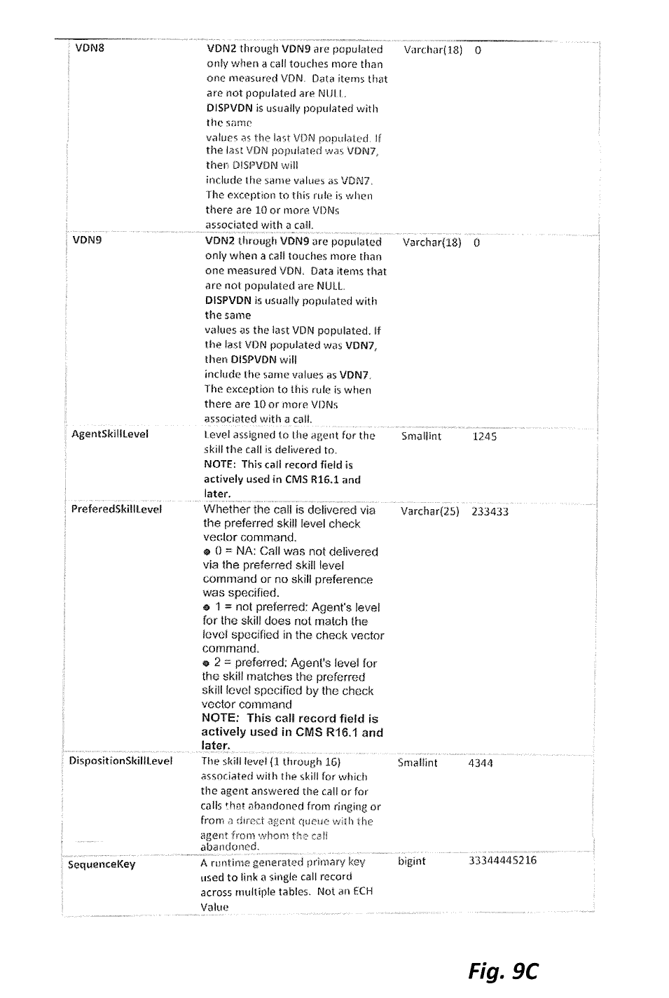

As raw data from the files generated by data logger 16 are harvested and transformed by the application program control by the report server 18 to place the data into tables of the database 20, data related to the way call segments flowed through switch 12 is stored in the SplitVDNs table illustrated in FIGS. 9A-9C. A split, also known as a skill, identifies the skill level of the agent who handled the call segment. A VDN is essentially an address of a device, such as the address of one of the workstations 10a-10n which handled the call segment. A vector is the processing logic used by the communication server 14 to get the call from a VDN to a skill.

Data stored in the SplitVDNs table illustrated in FIGS. 9A-9C again includes the unique call identifier for the call, the sequence number and the sequence key. These fields provide a relationship between the data stored in the SplitVDNs table related to a call segment and the data related to the same call segment stored in other tables. Other data recorded in the SplitVDNs table identifies each of the splits, VDNs and vectors employed during the call. For example, the first VDN is identified in the FirstVDN field. The VDN which disposed of the call is identified in the DispositionVDN field. Any intermediate VDN is separately identified in order in the VDN2-VDN9 fields. Likewise, the skill level of the agent receiving the call and the skill level of the agent who resolved the call, as well as a preferred skill level for resolving the call, can be recorded. The SplitVDNs table is also used to record the physical line the call came in on in the TrunkGroup field.

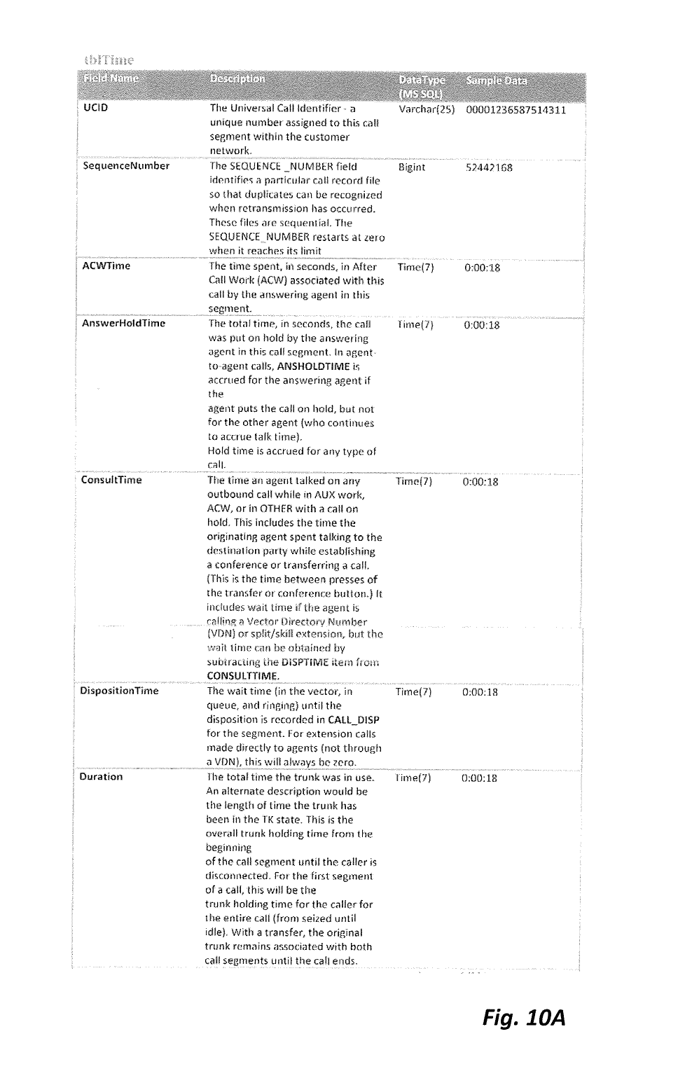

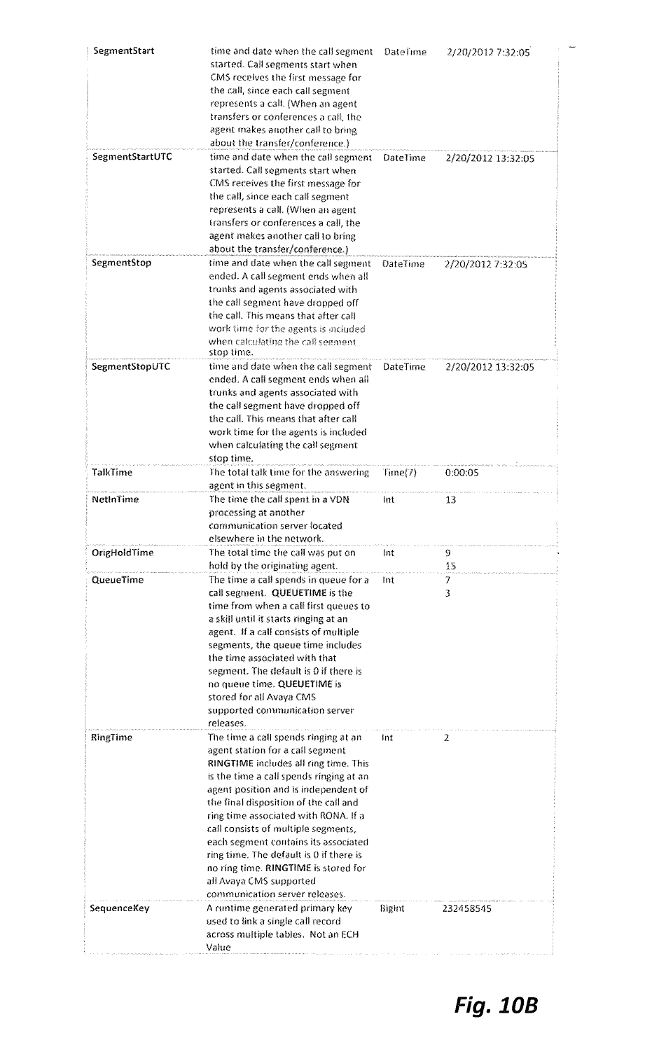

To monitor the efficiency of the call center, its equipment and its agents, time data buried in the logs created by the data logger 16 is extracted and stored in the Time Table illustrated in FIGS. 10A-10B. Again, to relate the time data concerning a particular call and/or call segment to the data for the same call and call segments stored in other tables, the UCID, sequence number and sequence key are all recorded in the Time Table. Time data separately recorded includes the time spent by the agent performing work related to the call after completion thereof (ACWTime), the time the caller spent on hold (AnswerHoldTime), the time the agent spent actually talking to the caller (ConsultTime), the total time which elapsed from when the call was received by the call center until the call was completed (DispositionTime), the start times (segment start and segment start UTC) and stop times (SegmentStop and SegmentStop UTC) of each segment, the actual time the agent and caller spoke with each other during the segment (TalkTime), etc. Queue time, hold time and ring time may also be recorded in the Time Table as reflected in FIG. 10B.

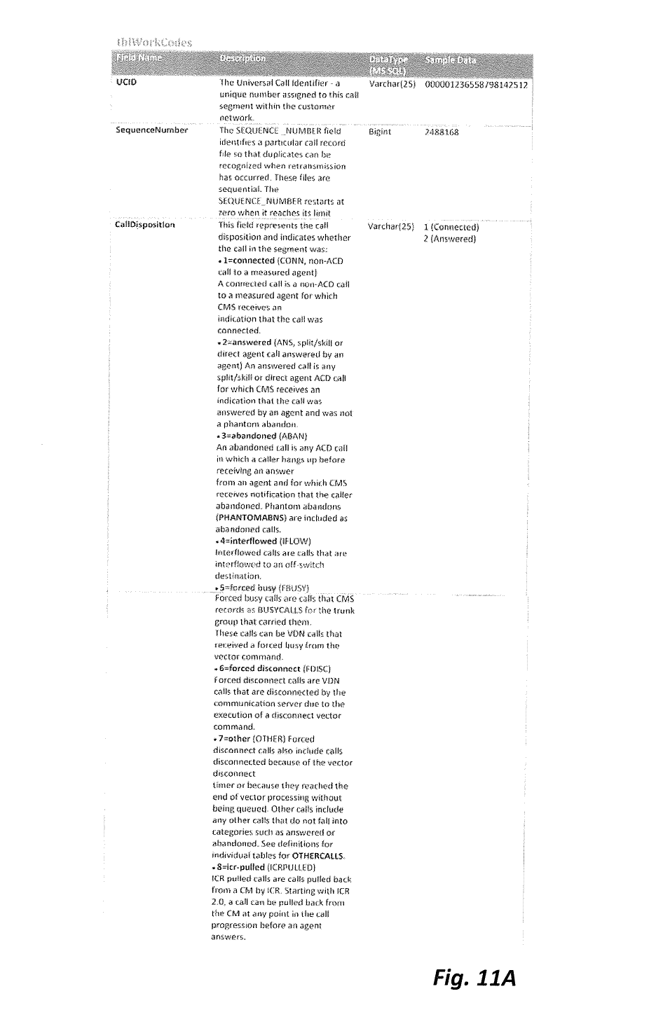

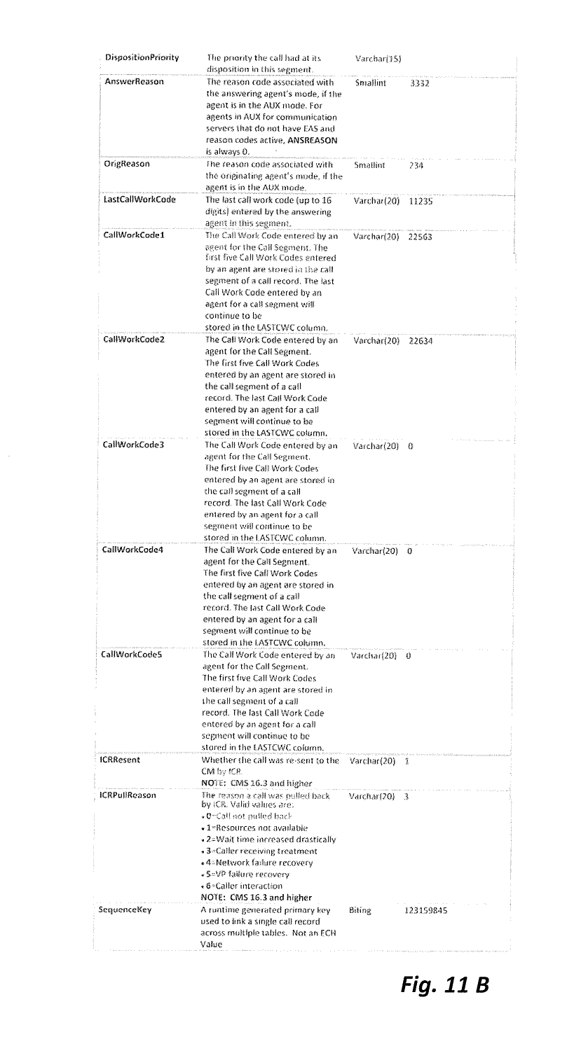

Modern call centers also permit agents to input data reflecting the nature of the services the agent provided on behalf of the caller during a call segment. The Work Codes table shown in FIGS. 11A-11B is used to store such information as may be extracted from a log file created by the data logger 16. To relate this date for a segment to data stored in other tables related to the same segment, the UCID, sequence number and sequence key are again stored in the WorkCodes table. Codes are also stored identifying the reasons for the call, the disposition of the call and the various tasks performed to dispose of the reasons for the call.

Performing the tasks required to retrieve and process the binary flat files generated by the data logger 16 to create the table entries discussed above is not a simple matter. Doing so requires retrieving binary encoded flat files, i.e., the log files, from the FTP server of the data logger 16 to create a local copy, parsing the local files and breaking them into individual records, converting the binary data into ASCII data while converting unreadable formatted numbers into times and migrating the data into the tables of a custom designed database.

While performing the foregoing steps, each file needs to be validated both as it exists on the data logger 16 and after a copy has been retrieved and stored locally in a temporary storage location accessible by report server 18. This requires that both of these files be parsed and compared byte by byte.

Further, the process of breaking down the file and inserting data into the various fields of the various tables of the database requires handling based on the explicit, specific version of the file. This information is typically supplied and encoded in the file itself and different file versions are out of necessity processed differently. One reason is different file versions have differing field sizes and positions within the file. Time and numbers are also provided differently in the different file versions. Some are in Unix format, while others are not. Some begin with a date and time while others do not. Some report time in seconds and read in bytes from left to right while others report time in minutes and read in bytes from right to left. Even numbers are represented differently in the different versions of the raw binary data files created by the data logger 16. For example, release 16.2 of the above-referenced data logger sold by Avaya outputs a “0” integer value not as a “0”, but as 65,535. Release 16.1 represented a “0” integer value as −65.534.

The report server 18 is designed to process the files being transformed across many threads simultaneously. For each file retrieved from the data logger 16 and stored locally by the report server 18, a first thread will break down the file, a second thread will handle dynamic conversion of the data while dissemination of the file is handled by the first thread, a third thread is creating the database queries to insert the data into the correct tables and table fields of the database as the database was preconfigured, and a fourth thread is taking those queries and interacting with the database, validating successful interactions with each query executed.

The software is also constantly determining whether any thread has failed and pauses all threads until the failure is resolved whenever a failure is encountered. An e-mail is generated if the failure has not automatically been resolved within three minutes. The e-mail describes the issues, requests action or investigation, and is sent to the addresses specified at step 64 in FIG. 3. To aid in troubleshooting, details such as the IP address, user name the software is utilizing, and the like are also included in the e-mail. After the e-mail is sent, the application program of the report server 18 checks once every sixty (60) seconds for so long as the issue persists. Once such a check results in recognition by the application program that the problem has been resolved, processing resumes.

Once the data has been successfully converted, the application program of the server, in cooperation with the server's operating system software, generates and delivers reports. Some reports are generated automatically while others result from queries entered by a manager, supervisor or other authorized user. These reports can be delivered electronically to the supervisor workstations 22a-c, to the printer 24 or stored in any accessible storage device on the network (e.g., storage 20). As used throughout this specification, the term “storage device” is to be given its broadest reasonable interpretation. By way of example and without limitation, it may be a single hard drive or an array of hard drives. Likewise, storage equipment other than hard drives may serve as a storage device. Such reports may also be delivered as e-mail, a text message or the like to any remote device capable of receiving the reports via the switch 12, gateway 5 and either the local area network, wide area network, or global network such as the Internet.

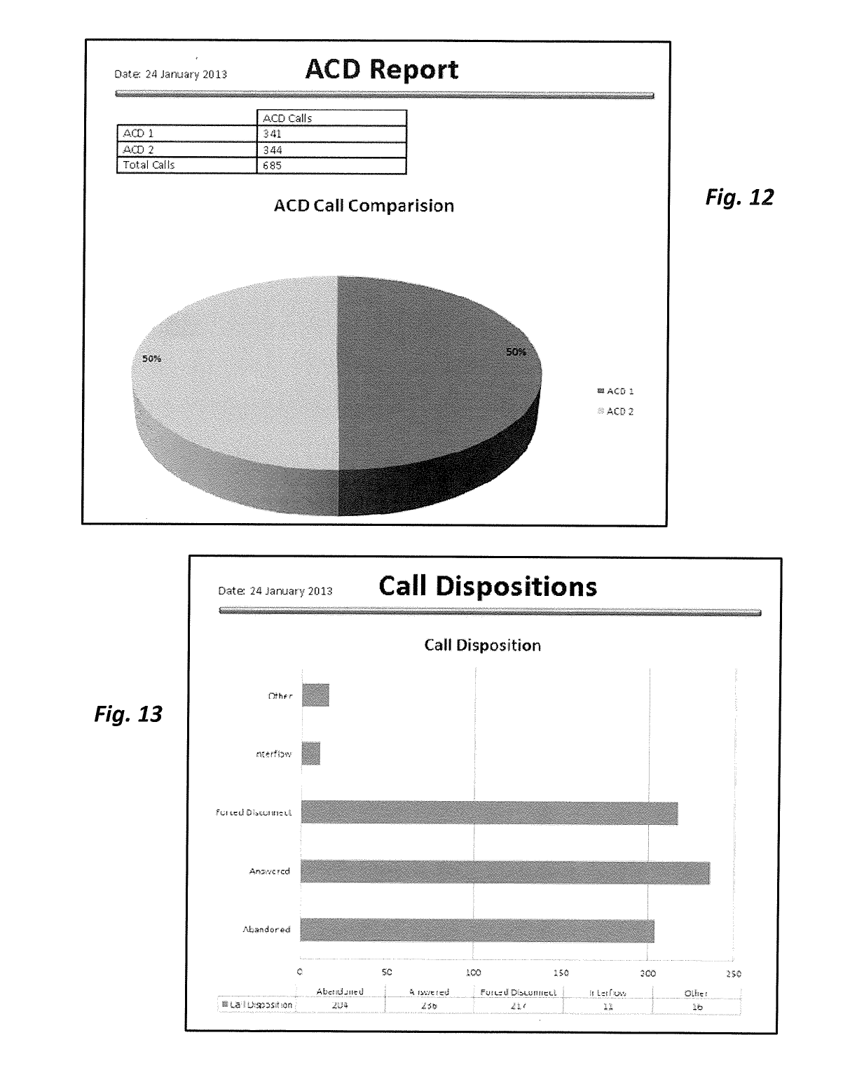

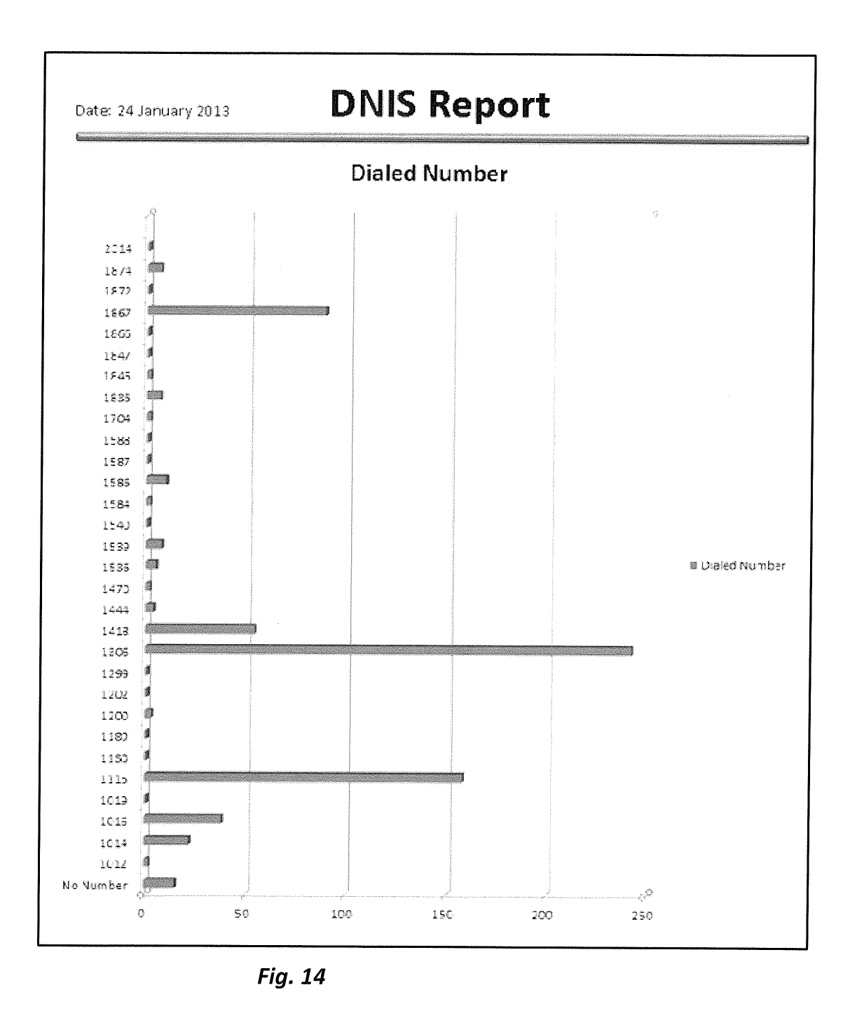

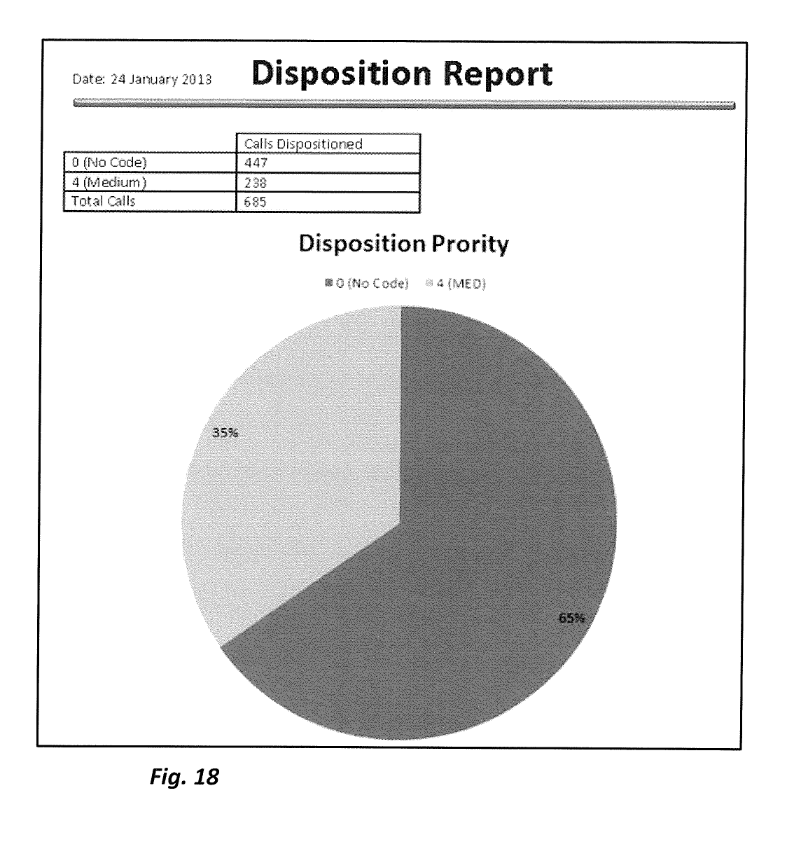

FIGS. 12 through 18 are examples of the many different reports which may be created and delivered. Some reports will provide information related to the call center equipment. See, for example, FIGS. 12 and 14. The automatic call distribution report of FIG. 12 indicates the two automatic call distribution groups of call center equipment are handling virtually the same number of calls suggesting equipment resources are being properly utilized. The dialed number identification report of FIG. 14 suggests almost all calls received are as a result of six of the thirty available numbers being dialed. The information can be used to assess the viability and effectiveness of advertising programs and to plan and assess changes.

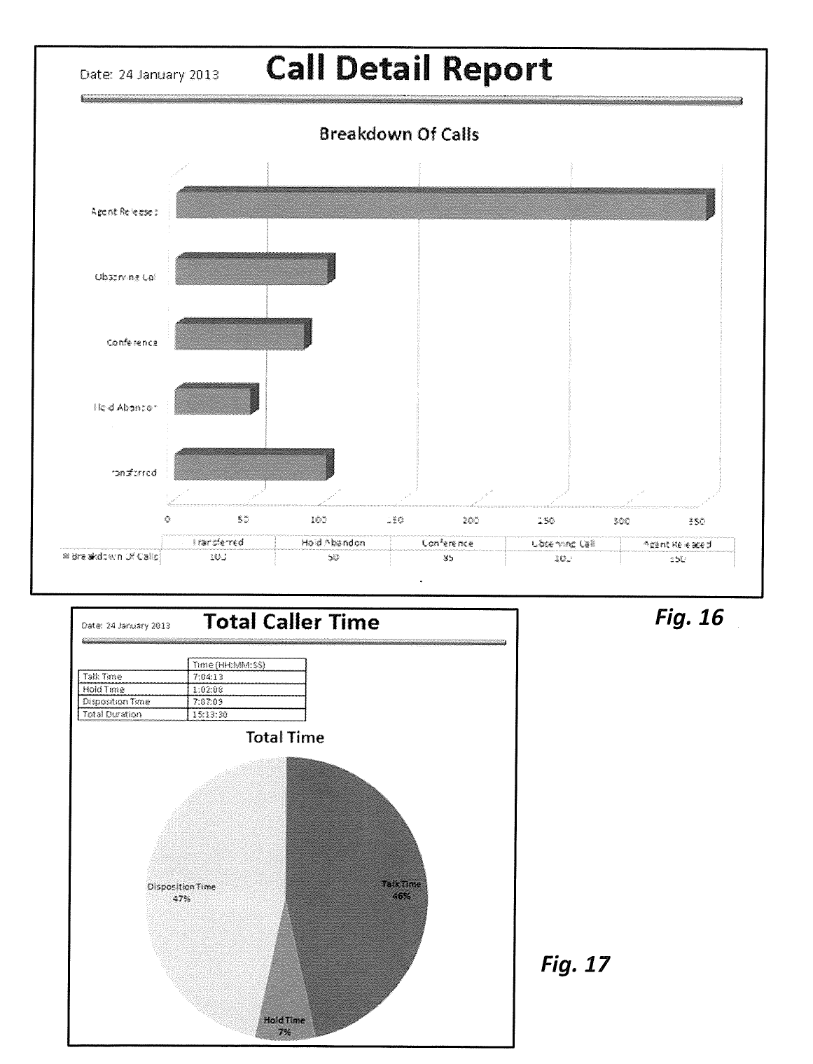

Other reports relate to the performance of the call center. Examples of such reports are shown in FIGS. 13, 16 and 18. The call disposition report of FIG. 13 shows, for example, how many calls were disconnected, answered or abandoned. The call detail report of FIG. 16 identifies how many calls were transferred, abandoned while on hold, handled by multiple agents in conference, monitored by an observer and released by an agent. The Disposition Report provides an indication of how many calls were given a specific disposition priority.

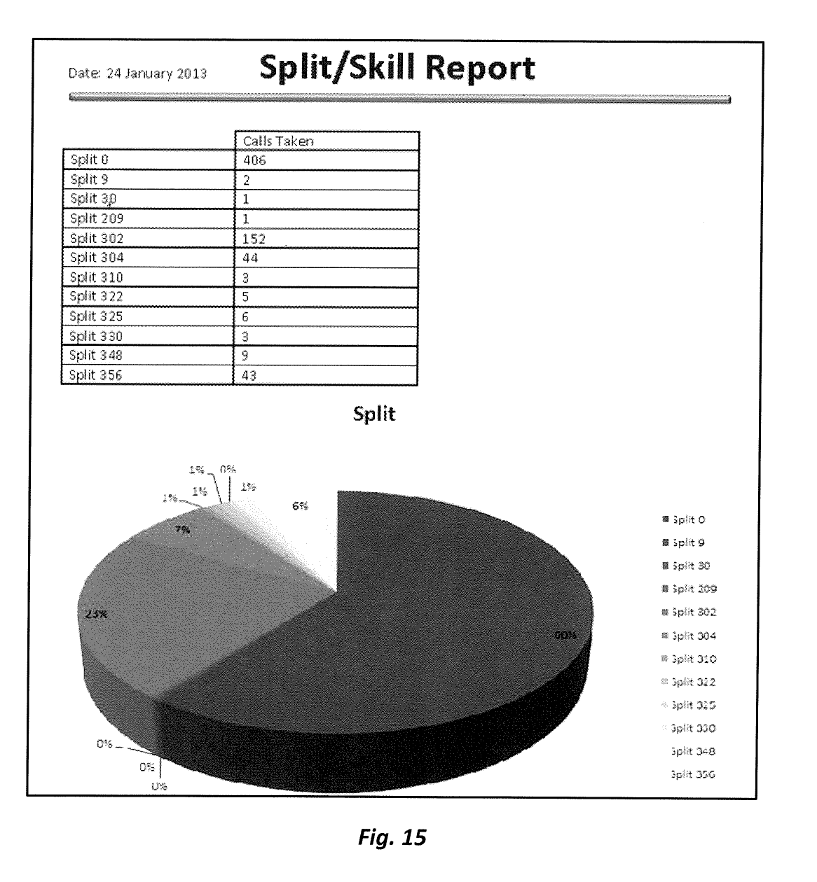

Still other reports relate to the performance of a specific agent or group of agents. FIG. 15, for example, shows how many calls were handled by each split. A split is a group of agents having a specific skill level. The split may have a single agent or multiple agents. A report such as the total caller time report shown in FIG. 17 may be prepared for each agent to show how much of the agent's time during a specific period was spent talking to callers (talk time), with a caller on hold (hold time) or following up after the caller hung up. By comparing such reports for the individual agents, a supervisor can spot agents falling out of a normal range (for example, the agent leaving callers on hold for an excessive period) so the issue can be addressed.

Again, the reports shown in FIGS. 12-18 are exemplary and many other automated reports may be generated. These may be customized to meet the needs of a particular supervisor or agent. Alternatively, custom reports can be created by a supervisor using the application program to query the database.

What is claimed is:

1. For use with a data logger which logs data related to calls handled by agents of a call center by creating log files containing data related to a plurality of calls, a call center management report generation apparatus comprising: a processor, at least one storage device, a database comprising a first set of tables and a second set of tables stored in said at least one storage device, a communications port, operating system software, and an application program which cooperates with the operating system software to control the call center management report generation apparatus such that the report generation apparatus processes at least one log file containing data related to a plurality of calls created by the data logger by (i) communicating with the data logger through the communications port to retrieve the at least one log file and store the at least one log file in a temporary storage location of the at least one storage device, (ii) transforming data contained in the at least one log file stored in the temporary storage location into a searchable form by creating in the first set of tables for each of the plurality of calls a separate set of entries, the entries in each table of the first set of tables related to each particular call segment including the UCID number, sequence number and sequence key of the particular call segment to uniquely identify the particular call segment and correlate the data related to the particular call segment contained in the plurality of tables of the first set of tables, the entries in the first set of tables also including for each call segment data related to actions taken by a caller, equipment used by the call center to handle the call, an identity of particular agents who handled the call segment, actions taken by the agents to assist the caller and timing of events related to the call, (iii) creating in the database at least one table containing data related to processing of the at least one log file and any errors occurring during processing of the at least one log file; and (iv) using the database to generate management reports in near real time, including information related to at least one topic selected from the group of topics consisting of operation of the call center equipment, performance of the call center, and performances of agents handling calls using the call center.

2. The call center management report generation apparatus of claim 1 wherein the application program causes the report generation apparatus to periodically check for and process any new log files created by the data logger.

3. The call center management report generation apparatus of claim 1 wherein the application program causes the call center management report generation apparatus to create and store for a predetermined period of time an archival copy of the at least one log file.

4. The call center management report generation apparatus of claim 1 wherein the types of data stored related to errors occurring during processing of the at least one log file are selectable.

5. The call center management report generation apparatus of claim 1 wherein the application program and operating system software cooperate to permit the database to be queried and custom reports to thereby be generated.

6. A call center management report generation apparatus comprising:
a. a data logger comprising a first processor, a first storage device, at least one first communications port and a first application program which controls the data logger such that the data logger (i) ingests through the at least one communications port data related to a plurality of calls handled by a call center, (ii) creates a log file containing said data and (iii) stores the log file in said first storage device;
b. a report server comprising a second processor, a second storage device, at least one second communications port, operating system software, a database comprising a first set of tables and a second set of tables stored in said second storage device, and a second application program which cooperates with the operating system software to control the report server such that the report server processes the log file by (i) communicating with the data logger through the at least one first communications port and the at least one second communications port to retrieve the log file, store the log file in a temporary storage location in the second storage device, and then delete the log file from the first storage device, (ii) transforming data contained in the log file stored in the temporary storage location in the second storage device into a searchable form by creating in the first set of tables of the database, for each segment of the plurality of calls, a separate set of entries, the entries in each table of the first set of tables related to each particular call segment including a UCID number, sequence number and sequence key of the particular call segment to uniquely identify the call segment and correlate data related to the call segment contained in a plurality of tables of the first set of tables, the entries in the first set of tables also including, for each call segment, data related to actions taken by the caller, equipment used by the call center to handle the call, the identity of particular agents who handled the call segment, actions taken by the agents to assist the caller and a timing of events related to the call, (iii) creating in the second set of tables of the database entries containing data related to processing of the log file and any errors occurring during processing of the log file; and (iv) using the database to generate management reports in near real time including information related to at least one topic selected from a group of topics consisting of operation of the call center equipment, performance of the call center, and performances of agents handling calls using the call center.

7. The call center management report generation apparatus of claim 6 further comprising a management workstation comprising a third processor and at least one further communications port, and wherein the second application program causes the report server to deliver at least one of the management reports in near real time to the management workstation.

8. The call center management report generation apparatus of claim 6 wherein the second application program causes the report server to periodically check for and process any new log files stored in the first storage.

9. The call center management report generation apparatus of claim 6 wherein the second application program creates an archival copy of the log file and stores the archival copy for a predetermined period of time.

10. The call center management report generation apparatus of claim 6 wherein the types of data stored related to errors occurring during processing of the log file are selectable.

11. The call center management report generation apparatus of claim 6 wherein the second application program and operating system software cooperate to permit the database to be queried and custom reports to thereby be generated.

12. A method for providing call center management reports comprising the steps of:
a. Providing a data logger comprising a first processor, a first storage device, at least one first communications port and a first application program which controls the data logger;
b. Providing a report server comprising a second processor, a second storage device, a database comprising a first set of tables and a second set of tables stored in said second storage device, at least one second communications port, operating system software, and second application program which cooperates with the operating system software to control the report server;
c. Using the data logger to ingest data related to a plurality of calls handled by a call center, create a log file containing at least some of the data related to a plurality of calls, and store the log file in the first storage; and
d. Using the report server to process the log file by (i) communicating with the data logger through the at least one first communications port and the at least one second communications port to retrieve the log file, store the log file in a temporary storage location in the second storage device, and then delete the log file from the first storage, (ii) transforming data contained in the log file stored in the temporary storage location into a searchable form by creating in the first set of tables of the database, for each segment of the plurality of calls, a separate set of entries, the entries in each table of the first set of tables related to each particular call segment including a UCID number, sequence number and sequence key of the particular call segment to uniquely identify the call segment and correlate the data related to the call segment contained in the plurality of tables of the first set of tables, the entries in the first set of tables also including, for each call segment, data related to actions taken by the caller, equipment used by the call center to handle the call, the identity of particular agents who handled the call segment, actions taken by the agents to assist the caller and the timing of events related to the call, (iii) creating in the second set of tables of the database entries containing data related to processing of the log file and any errors occurring during processing of the log file; and (iv) using the database to generate management reports, in near real time, including information related to at least one topic selected from a group of topics consisting of operation of the call center equipment, performance of the call center, and performance of agents handling calls using the call center.

13. The method of claim 12 further comprising the step of delivering at least one of the management reports in near real time to a management workstation.

14. The method of claim 12 further comprising the step of causing the report server to periodically check for and process any new log files stored in the first storage.

15. The method of claim 12 further comprising repeating steps (c) and (d).

16. The method of claim 12 further comprising the steps of creating an archival copy of the log file and storing the archival copy for a predetermined period of time.

17. The method of claim 12 further comprising the steps of creating a query, processing the query to retrieve data from the database, and generating a custom report using the retrieved data.
